(19) United States
(12) Patent Application Publication
(10) Pub. No.: US 2010/0275950 A1
(43) Pub. Date: Nov. 4, 2010

(54) METHOD AND DEVICE FOR THE TREATMENT OF SURFACES

(76) Inventors: Helmut Mack, Traunstein (DE); Tobias Austermann, Rosenheim (DE); Martin Ebner, Kissing (DE); Michael Leck, Braunschweig (DE); Wolfgang Viöl, Adelebsen (DE)

Correspondence Address: FULBRIGHT & JAWORSKI, LLP, 666 FIFTH AVE, NEW YORK, NY, 10103-3198, US

(21) Appl. No.: 12/741,861

(22) PCT Filed: Dec. 9, 2008
(86) PCT No.: PCT/EP2008/067058

§ 371 Date: Jul. 21, 2010

(30) Foreign Application Priority Data
Dec. 10, 2007 (EP) 07122801.9

(51) Int. Cl. C03C 23/00; C23F 1/08

(52) U.S. Cl. 134/1.1; 156/345.44

(57) ABSTRACT

The invention relates to a device and a method for the treatment of surfaces with a plasma produced under atmospheric pressure. The device according to the invention is formed as a portable handheld unit and comprises a plasma nozzle (16) for producing a plasma jet (18), which comprises a nozzle opening (17) and at least one electrode and counter-electrode pair (27, 28) arranged upstream of the nozzle opening, the effective electrode surfaces of which pair of electrodes each have a dielectric coating (29, 30), the electrode (27) and the counter-electrode (28) defining between them a working space (34) in which a working gas can be at least partially ionized by means of a dielectric barrier gas discharge, a high-voltage generator (19, 20), which is electrically connected to the electrode and counter-electrode pair (27, 28), a feeding means (15), which produces a gas flow of the working gas from a working gas source into the working space (34) and through the nozzle opening (17), the working gas source being ambient air, and a mains-independent energy source (12) for supplying the high-voltage generator (19, 20) and the feeding means (19).

The present invention relates to a device and a method for the treatment of surfaces with a plasma produced under atmospheric pressure.

The treatment of surfaces of objects of a wide variety of materials plays an important role in many areas of industrial technology. A wide variety of properties in terms of processing and durability can be improved by suitable surface treatment, in particular by cleaning the surface. A surface treatment can also often improve the adhesion of a subsequently applied coating material to the treated surface.

For the treatment, in particular cleaning, of surfaces, in the past there has often been a reliance on wet-chemical methods, in which organic solvents are usually used. On account of the environmental and health risks that are associated with organic solvents, there is a need for low-cost, energy-saving and environmentally benign alternatives for the treatment of surfaces.

The treatment of surfaces with a plasma produced under atmospheric pressure represents a promising alternative that does not require the use of solvents, adhesion promoters or other hazardous materials and is suitable for the surface treatment of a wide variety of materials, such as plastics, metals, ceramics, glasses, building materials, such as for example concrete, or organic materials, such as for example wood. The production of a plasma under atmospheric pressure has the associated advantage that, by contrast with low-pressure plasmas or high-pressure plasmas, no reaction chamber is required for producing a pressure level other than atmospheric pressure.

An atmospheric-pressure plasma is understood in the present context in the broadest sense as meaning an excited working gas which contains reactive components produced by supplying electrical energy and the pressure of which substantially corresponds to ambient pressure or atmospheric pressure. The reactive components may be unstable neutral components, such as for example ozone, radicals, such as free or excited oxygen, or ionized atoms or molecules. The atmospheric-pressure plasma will usually contain at least partially ionized working gas.

For the (partial) ionization of the working gas, energy must be introduced into the working gas. This can take place for example by high-voltage discharge by means of high-voltage pulses or else by radiowave or microwave excitation of the working gas.

Systems for surface treatment by means of a plasma produced under atmospheric pressure that have previously been described in the literature or are commercially available often have a high power consumption, great weight and large dimensions. Furthermore, special working gases, such as for example argon or helium, are often used, with the result that the treatment device has to be connected to a corresponding gas supply device. Such units are therefore not suitable for mobile use or only to a restricted extent.

The German patent application DE-A-103 24 926 of a coinventor of the present application describes a device for the treatment of a biological material containing living cells with a plasma produced by a gas discharge under atmospheric pressure in which high-voltage pulses are applied between an electrode and the material to be treated, serving as a counter-electrode, the electrode having a dielectric coating, with the result that the gas discharge takes place in the form of a dielectric barrier discharge (also referred to as a DBD). On account of the low power consumption, the unit described there can be realized as a battery-operated handheld unit. However, a disadvantage of the device known from DE-A-103 24 926 is that the material to be treated acts as a counter-electrode, with the result that the materials treated with this device are subject to certain restrictions, since for example the material must have a certain conductivity. On account of the geometry of the electrode of the known device, in which the plasma is produced between a rod-shaped electrode and the material to be treated, relatively large, in particular inhomogeneous, surface regions cannot be treated uniformly.

The German patent application DE-A-101 16 502 of a coinventor of the present application describes a further device for the treatment of surfaces by means of a plasma produced under atmospheric pressure in which the material to be treated does not serve as a counter-electrode. Rather, the device described there has an electrode and a counter-electrode, between which a plasma that is expelled from a nozzle in the form of a plasma jet is produced by means of a dielectric barrier discharge. The gas duct of the known device comprises a shaped body of electrical insulating material, to which an electrode and a counter-electrode are attached. However, the tubular geometry of the gas duct of the device of DE-A-101 16 502 does not allow a homogeneous discharge, with the result that it is disadvantageous for the treatment of relatively large surface areas such as surfaces of joints.

The present invention is based on the technical problem of providing a device for the treatment of surfaces with a plasma produced under atmospheric pressure that is lightweight, compact and energy-saving, with the result that it can be formed in particular as a mains-independent handheld unit, and at the same time allows a long service life. At the same time, the invention is intended to make it possible for large surface areas to be treated quickly and uniformly.

This technical problem is solved by the device according to the present main claim. Advantageous developments of the invention are the subject of the dependent claims. The invention accordingly relates to a device for the treatment of surfaces with a plasma produced under atmospheric pressure having a plasma nozzle for producing a plasma jet, which comprises a nozzle opening and at least one electrode and counter-electrode pair arranged upstream of the nozzle opening with respect to the direction in which the plasma jet emerges from the nozzle opening, the effective electrode surfaces of which pair of electrodes each have a dielectric coating, the electrode and the counter-electrode defining between them a working space in which a working gas can be at least partially ionized by means of a dielectric barrier gas discharge, a high-voltage generator, which is electrically connected to the electrode and counter-electrode pair, a feeding means, which produces a gas flow of the working gas from a working gas source into the working space and through the nozzle opening, the working gas source being ambient air, and a mains-independent energy source for supplying the high-voltage generator and the feeding means.

The device according to the invention has numerous associated advantages.

The use of a dielectric barrier discharge for producing the plasma makes it possible to initiate a gas discharge under atmospheric pressure with low electrical power of only a few watts. Therefore, no high-voltage power supply unit is required for operating the device according to the invention, but instead the a.c. voltage for initiating and maintaining the gas discharge can be produced just by using electrical energy from commercially available batteries or storage batteries.

According to the invention, ambient air is used as the working gas, with the result that no gas connection or external gas sources are required.

The device according to the invention comprises a feeding means for sucking in the ambient air and for transporting the ambient air into the working space, where the air is at least partially ionized, and for expelling the ionized air as a plasma jet from the nozzle opening of the plasma nozzle. A wide variety of types of pumps and compressors are suitable as feeding means. Particularly preferred are pumps and compressors with small dimensions and low power consumption, such as for example a diaphragm pump.

The low power consumption both of the high-voltage generator for plasma production and of the feeding means for producing a plasma jet make it possible to use a mains-independent energy source.

It has also surprisingly been found that in many application cases a surface treatment with the device according to the invention makes it unnecessary to carry out any further surface treatment.

According to a preferred embodiment, the electrode and the counter-electrode are formed as planar electrode plates arranged parallel to each other. Such an arrangement of the plane-parallel electrodes results in a slit-shaped outlet opening. This facilitates uniform treatment of relatively large surfaces. According to a first embodiment, the device comprises one pair of electrodes. In other embodiments, however, it is also possible for a number of pairs of electrodes to be arranged in parallel or in series to ensure a greater outlet cross-section of the plasma jet. To increase the outlet cross-section of the plasma jet, it is also possible to arrange between the pair(s) of electrodes one or more plates of a dielectric material that are parallel to the pairs of electrodes and separated from them by dielectric spacers.

The dielectric coating may consist of a wide variety of materials. Materials that are puncture-proof under the voltage amplitudes used, such as for example ceramic materials, such as aluminium oxide or boron nitride, quartz glass or diamond, are preferred. If the stated materials are used, the layer thickness of the dielectric coating lies in the millimetre range, for example in the range from 0.5 to 2 mm.

The clear distance between the coated electrode and the coated counter-electrode advantageously lies in the range from 0.1 mm to 10 mm, preferably in the range from 0.5 mm to 2 mm, and with particular preference at approximately 0.6 mm.

The width of the electrode and of the counter-electrode transversely in relation to the direction of the gas flow is preferably equal and lies for example in a range from 5 to 100 mm, preferably in the range from 10 to 50 mm and with particular preference at approximately 20 mm. The width of the electrode transversely in relation to the direction of the gas flow in this case corresponds substantially to the width of the slit-shaped nozzle opening.

According to a preferred embodiment of the device according to the invention, the high-voltage generator produces anti-symmetric high-voltage pulses, which lie with opposite polarity at the electrode and the counter-electrode at the same time. On account of the mechanically symmetrical construction of the electrode and the counter-electrode, and the anti-symmetric voltage profile at the electrodes, the plasma flowing out is virtually potential-free. Therefore, a user inadvertently coming into contact with the plasma gas stream, for example with a finger, does not suffer an electric shock. The device according to the invention can therefore be handled easily and safely. It is also ensured that the treatment effect of the surface is independent of the electrical conductivity of the surface to be treated.

The plasma jet preferably has a temperature in the range from 30 to 60° C. The temperature near the lower end of the stated temperature range is particularly preferred if temperature-sensitive substrates are to be treated. At the upper end of the stated temperature range, the further advantage that possibly occurring ozone is already destroyed again is achieved, with the result that there is no need to provide additional means for extracting ozone by suction in order that the health of the user is not adversely affected. In any event, in the preferred temperature range there is no possibility of the user being burned or otherwise injured, even if the device according to the invention is operated incorrectly. The temperature of the plasma jet is preferably controlled by means of the gas velocity or the gas throughflow and/or the electrical power fed in. These parameters may be fixed or allow themselves to be changed by the user.

The high-voltage generator preferably produces high-voltage pulses with an amplitude in the range from 1 to 20 kV and preferably in the range from 5 to 15 kV. The pulse repetition frequency advantageously lies in the range from 1 to 50 kHz, with particular preference in the range from 10 to 25 kHz. Preferably, high-voltage pulses with a pulse duration of less than 1 μs are produced, particularly advantageously in the form of bipolar pulses.

The power required for initiating and maintaining the gas discharge lies in the range of one or a few watts. The power consumption of the feeding means, for example the diaphragm pump, for producing the gas stream is only a few watts. Altogether, the power consumption of the high-voltage generator and of the feeding means is therefore at most 20 W, preferably at most 10 W. Consequently, one or more batteries or one or more storage batteries may be used as the mains-independent energy source. Typical commercially available storage batteries, such as are also used for example in battery-powered screwdrivers popular in the DIY sector, have a typical capacity of approximately 20 watt hours. With a total electrical power of the high-voltage generator and the feeding means of altogether 10 W, such a storage battery therefore allows uninterrupted use for about 2 hours.

According to an advantageous embodiment of the device according to the invention, the plasma jet emerging from the nozzle opening contains at least one marking substance. In the present context, a marking substance or “tracer” is understood as meaning a substance that is deposited on the treated surface during the plasma treatment of the surface and can later be detected, with the result that it is subsequently possible to verify whether a certain surface region has been treated with the plasma jet. This may be of interest in particular in the case of applications where security is critical, in order to detect in the case of damage whether or not a plasma pretreatment of the relevant surface was carried out. The marking substance or “tracer” may occur in very low concentration, with the result that even the slightest traces of the corresponding tracer atoms or molecules still detectable by the respective method of detection on the treated surface are sufficient to document the plasma treatment that has taken place. It can also be verified on the basis of the concentration of the tracer on the treated surface whether an adequate treatment time was maintained. The marking substance or “tracer” may be a gas or a readily volatile liquid, which is sucked into the plasma nozzle via a gas intake connector and expelled there with the plasma jet. The marking substance is preferably arranged in a reservoir integrated in the device according to the invention, it being possible for a communicating connection to be established between the reservoir and the plasma nozzle. In many cases, the dynamic negative pressure produced when the plasma jet in the plasma nozzle is expelled is adequate to suck the marking substance out of the reservoir into the plasma nozzle. However, the reservoir may also be provided with an integrated feed pump.

Alternatively, the feeding means for producing a gas flow of the working gas may also be used for producing a small positive pressure in the reservoir, to assist the expulsion of the marking substance into the plasma nozzle. In this case, the tracer is preferably introduced into the plasma jet after the plasma is produced between the electrode plates. All substances that can be applied immediately before, at the same time as or immediately after the plasma treatment of the treated surface region and later detected are suitable as the tracer. With preference, the tracer will be applied together with the plasma jet, since only in this way can it be unequivocally detected whether a plasma treatment has been carried out. The tracer may already take the form of a gas or initially the form of a solid body or a liquid, which is then vaporized. In the last two cases, the tracer can be introduced into the plasma jet by melting, vaporizing, sublimating, atomizing or similar methods. Suitable tracers are, for example, fluoropolymers, chlorosilanes such as SiCl₄, which can be detected for example by mass spectrometry, or fluorescent dyes, which can be detected optically, for example by excitation with UV light.

With particular preference, the device according to the invention is formed as an integrated portable handheld unit which comprises the plasma nozzle, the high-voltage generator, the feeding means for producing the gas flow of the working gas and the mains-independent energy source. The handheld unit may take the general form similar to a gun, such as that known for example from commercially available battery-powered screwdrivers. For this purpose, the handheld unit preferably has a handle, which serves at the same time as a receptacle for the mains-independent energy source (that is to say for example batteries and/or storage batteries). The plasma nozzle may be arranged in an immovable or rotatably arranged head of the handheld unit.

The present invention also relates to a method for the treatment of surfaces, it being possible for the device according to the invention to be used to produce a directed plasma jet from the ambient air and for a surface of at least one component to be treated with the plasma jet.

The device according to the invention and the method according to the invention are suitable with particular preference for the treatment of the surface of a substrate such as concrete, mortar, plaster, gypsum, stone, stoneware, tiles, steel, further metals and alloys (lubricated and unlubricated), wood, paper, leather, glass, Plexiglass® and similar plastic glasses, carbon-fibre and carbon-fibre composite materials, plastics, for example polysulphone, thermoplastic olefins (TPO), polyurethanes (PU) and thermoplastic polyurethane elastomers (TPU), for example for moulded parts, Bakelite®, polycarbonate (PC), polyester (PES), polyethylene terephthalate (PET), polybutylene terephthalate (PBT), acrylonitrile-butadiene rubber (NBR), styrene-butadiene rubber (SBR), chloroprene rubber (CR), butadiene rubber (BR), ethylene-propylene-diene rubber (EPDM), polyacetals, polyamides, polyacrylonitriles, aminoplastics, expanded or unexpanded polystyrene, polyvinyl chloride, polyethylene, polypropylene, melamine resins, acrylonitrile-butadiene-styrene copolymer, fluoropolymers such as polytetrafluoroethylene, acrylates, silicone resin coatings, silicone elastomers, expanded or unexpanded polyurethane coatings, synthetic epoxy resin compounds, polysulphides, acrylic coatings, hybrid coating systems such as modified-silane polymers (MS polymers), silylated polyurethanes or polyurea silicate, varnish, lacquer or paint coatings or textiles.

The surfaces plasma-treated by the device according to the invention may be coated for example with various materials. For coating the surfaces treated by the device according to the invention and the method according to the invention, silicone resin compounds, polyurethane compounds, police sulphide, acrylic compounds, butyl-based sealants and adhesives, synthetic epoxy resin compounds and hybrid coating systems such as MS polymers, silylated polyurethanes, polyurea silicate may be used for example as an adhesive and sealant, as a jointing compound for expansion joints or service joints, or else as a surface coating. For the coating of the plasma-fitted surface, foams, with preference polyurethane or polystyrene foams, may also be used. The device according to the invention may also be designed in such a way that the spray gun or similar unit used for application is integrated in the device, with the result that the treatment of the substrate surface and the application of the sealant or the adhesive compound can take place simultaneously or almost simultaneously in one operation.

According to one embodiment of the method according to the invention, the surfaces of two or more parts being joined, which are to be connected to each other, are treated with the plasma jet. After the treatment with the plasma jet, an integral bond can be produced between the parts being joined by using an adhesive or a sealant. The parts being joined may be produced from the same material or from different materials. Examples of suitable materials and material combinations and suitable sealants and adhesives have already been given above.

The method according to the invention is suitable in particular for use on building sites, to treat surfaces of structural elements. On account of its compact dimensions and the flexible, extremely mobile handling as a handheld unit, which does not have to be connected to external energy sources or to external gas sources, the device according to the invention is suitable in particular for the treatment of surfaces that are difficult to access and/or complex. With particular preference, the method according to the invention therefore relates to the treatment of the surface of a joint formed between two structural elements. With particular preference, the invention relates to pretreatment of a surface of a joint before the joint is sealed with a sealing material.

In the treatment of the surfaces of joints, the device according to the invention and the method according to the invention have the advantages that no counter-electrode is necessary on the substrate and the device according to the invention can be used without further modification for joints of a wide variety of geometries. The device according to the invention and the method according to the invention are suitable for the surface treatment of joints of different material pairings, for example for joints between structural elements of concrete and steel, ceramic and plastic and plastic and metal, such as for example aluminium.

The method according to the invention and the device according to the invention are suitable in the building sector and for new constructions, for example in the area of facades, for the treatment of isolation joints in buildings, in the sanitary and bathrooms sector, for example for the treatment of joints in shower cubicles, in the water-related sector, for example for the treatment of joints in swimming pools, or in building construction for the treatment of joints, but also in the corresponding areas of use for renovation work. Renovation work especially involves the problem that, before any new application of joint sealants, the joint has to be cleaned of remains of the old sealing material. This is so because such remains have an adverse influence on the bonding of the new sealant material and the substrate. In such a case, even use of a primer does not lead to any improvement of the adhesion. Therefore, until now the surface of the joint had to be laboriously removed with special tools, for example diamond cutters, and correspondingly re-profiled with mortar. This involves great expenditure of time and costs. With the method for plasma treatment according to the invention, it is possible to dispense with laborious mechanical treatment of joints even in the area of building renovation. It has surprisingly been found that, after the surface treatment with the plasma jet produced by means of the device according to the invention, new sealing material could be applied with good adhesion properties. Therefore, great cost savings are associated with the method for surface treatment according to the invention. Furthermore, the method according to the invention has the advantage that it is possible to dispense with primers and other chemical adhesion promoters. With the device according to the invention and the method according to the invention, the substrate surface can be modified or activated with a hydrophilizing effect in a preserving, nondestructive way by oxidation reactions with the excited gas of the plasma jet, which ensures inter alia better wetting of the substrate surface with aqueous coating systems. The treatment with cold plasma produces a hydrophilized and activated substrate surface, which improves the adhesion between the adhesive or sealing compound and the substrate surface. The method according to the invention is therefore also suitable in particular for surfaces contaminated by organic substances such as oils, waxes, greases or solvent remains or inorganic substances such as silicone resins, since such contaminants can for the most part be destroyed by the treatment with the cold plasma.

Apart from the building applications already mentioned, the method according to the invention and the device according to the invention have various industrial applications, such as for example for surface treatment in equipment manufacture, mechanical engineering, electrical engineering, in the transport sector such as for container construction, the textiles industry, the composite materials industry and the energy business.

The invention is explained in more detail below with reference to an exemplary embodiment that is represented in the accompanying drawing, in which:

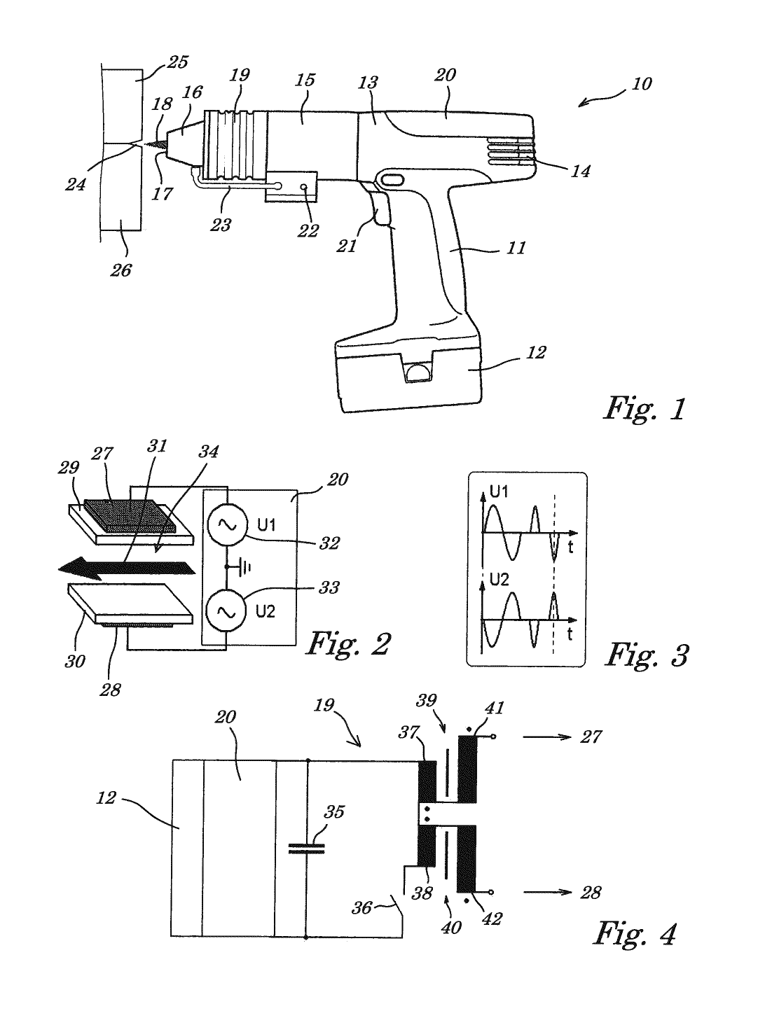

FIG. 1 shows a schematic side view of a device according to the invention, formed as a portable handheld unit;

FIG. 2 shows a schematic construction of the electrode arrangement for producing the plasma by means of a dielectric barrier discharge;

FIG. 3 shows the voltage profile of the high-voltage pulses lying at the electrode and the counter-electrode;

FIG. 4 shows the wiring of the high-voltage transformer for producing opposed voltage pulses at the electrode and the counter-electrode;

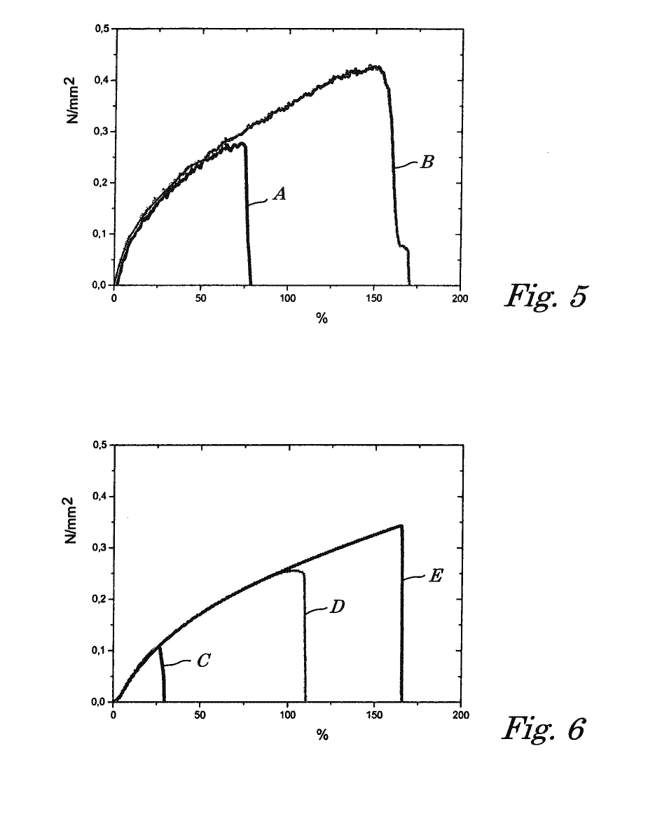

FIG. 5 shows the stress-elongation diagrams of a sealing compound applied to a new, brushed concrete surface; and

FIG. 6 shows stress-elongation diagrams of a sealing compound applied to a concrete surface contaminated with old sealing compound.

In FIG. 1, a handheld plasma-jet device according to the invention is represented, designated overall by the reference numeral 10. The handheld plasma-jet device 10 has a handle 11, on the underside of which a storage battery 12 is detachably fastened. An elongated housing body 13, arranged over the handle 11, has the components required for producing the plasma. Air slits 14, through which a diaphragm pump 15 sucks in ambient air and transports the air substantially axially through the housing body 13, are formed in the rear region of the housing body 13. Arranged downstream of the diaphragm pump 15 is a plasma nozzle 16, which ends in a nozzle opening 17, from which a plasma jet 18 emerges. The electrode arrangement located in the plasma nozzle for ionizing the air fed to it by the diaphragm pump 15 is represented in more detail in FIG. 2. Arranged between the plasma nozzle 16 and the diaphragm pump 15 is a high-voltage transformer 19, which is electrically connected to a high-voltage generator 20. The handheld plasma-jet unit 10 is actuated by means of a switch 21, which is arranged on the handle 11. An additional gas, for example a gas containing a marker or tracer, can be sucked into the plasma nozzle 16 via a gas intake connector 22 and a suction intake line 23 and sprayed together with the plasma jet 18 onto the surface to be treated. Finally, a joint 24, which is formed between two structural elements 25, 26, is schematically represented in FIG. 1. The surface of the joint 24 is treated by the handheld plasma-jet unit 10 according to the invention.

In FIG. 2, the construction of the electrode arrangement in the plasma nozzle 16 is schematically represented. The electrode arrangement comprises a pair of electrodes made up of an electrode 27 and a counter-electrode 28. The electrodes 27, 28 are formed as plane-parallel plates. The active surface of the electrode 27 and the active surface of the electrode 28 are each coated with a dielectric 29 and 30. The air stream produced by the diaphragm pump 15 (cf. FIG. 1) is schematically represented in FIG. 2 by the arrow 31 directed towards the nozzle opening 17 (cf. FIG. 1). As indicated by the voltage symbols 32, 33, the voltage U1 lies at the electrode 29 and the voltage U2 lies at the counter-electrode 28.

The voltage profile of the bipolar high-voltage pulses lying at the electrode and the counter-electrode is represented in FIG. 3. As can be seen, the voltage profiles at the electrodes are anti-symmetric, i.e. a positive voltage pulse at the electrode 27 has a corresponding equal and opposite negative voltage pulse at the counter-electrode 28, and vice versa. Defined between the electrode 27 and the counter-electrode 28 is a working volume 34, in which the air flowing through is at least partially ionized by means of a dielectric barrier discharge by the application of the voltage pulses, and finally, as indicated in FIG. 1, emerges from the handheld plasma-jet unit 10 as plasma jet 18.

In FIG. 4, the wiring of the high-voltage transformer 19 of FIG. 1 is schematically represented. The high-voltage generator 20 draws the necessary energy for producing the anti-symmetric high-voltage pulses from the storage battery 12. The amplitude of the anti-symmetric high-voltage pulses is up to ±15 kV. The pulse repetition frequency, typically lying in the range between 10 and 25 kHz, and the amplitude are variable and can be controlled by the high-voltage generator. To produce the high-voltage pulses, a storage capacitor 35 is charged to a set voltage value of between 30 and 280 V. The stored charge in the storage capacitor 35 or the voltage across the latter determines the amplitude of the high-voltage pulses. When a predetermined voltage is reached, the storage capacitor is discharged by a solid-state switch 36 via the primary windings 37, 38 of two high-voltage transformers 39, 40. The rapid change in current induces a voltage pulse. In accordance with the winding ratio between the primary winding 37 and the secondary winding 41 of the first high-voltage transformer 39 and the winding ratio between the primary winding 38 and the secondary winding 42 of the second high-voltage transformer 40, the voltage pulse is stepped up on the secondary side of the high-voltage transformers. The high-voltage transformers 39 and 40 simultaneously supply voltage pulses with the same absolute amplitude but opposite polarity, which then lie at the electrode 27 and the counter-electrode 28.

The invention is now explained in more detail on the basis of comparative examples.

### EXAMPLE 1

### Adhesion and Elongation Behaviour of a Sealant on a New Concrete Formwork Part

The adhesion and elongation behaviour of the sealing compound PCI Silcoferm S (PCI Augsburg GmbH) was determined by means of stress-elongation measurements according to the standard EN ISO 9047.

For this purpose, a strip of the sealing compound of a width of 12 mm, a length of 50 mm and a layer thickness of 12 mm was respectively applied to an untreated brushed concrete surface of a new concrete formwork part and such a brushed concrete surface treated by the handheld plasma-jet unit according to the invention.

The handheld plasma-jet unit corresponded to the type represented in FIG. 1. To produce the plasma jet, an air stream with a throughflow rate of about 5 l/min was produced by means of the integrated pump and conducted through a pair of electrode plates (copper plates with a surface area of 200 mm², which had each been coated with a 0.6 mm thick layer of Al₂O₃ serving as a dielectric). The clear distance between the coated electrode plates was 0.4 mm. By applying a voltage of 10 kV, the air was partially ionized. The plasma jet produced in this way emerged through a nozzle, which had an outlet opening with a rectangular cross section 20 mm long and 0.4 mm wide. The distance from the nozzle opening to the concrete surface was approximately 2 mm, with the result that the effective cross-section of the jet on the concrete surface corresponded substantially to the cross-sectional area of the nozzle on account of the low divergence of the plasma jet flowing out. The plasma jet was moved manually over the concrete surface to be treated at a rate of about 19 mm/s. Immediately after the plasma treatment, the sealing compound was applied in the way described above to the untreated and treated surfaces.

Four weeks after the application of the sealing compound, stress-elongation curves were measured by static tensile testing. This involved pulling the specimens apart continuously at a rate of 10 mm/min until the rupture occurred.

The results are represented in FIG. 5. Curve A shows the results of the untreated surface. Curve B shows the results of the surface treated by the handheld plasma-jet unit according to the invention. It can be seen that the plasma treatment leads to a clear improvement in the adhesion properties, since the sealing compound on the treated surface is only torn when it undergoes an elongation of about 170% (as compared with about 80% in the case of the untreated surface).

### EXAMPLE 2

### Adhesion and Elongation Behaviour of a Sealant on a Concrete Framework Part from the Renovation of an Old Building

The experiment from Example 1 was carried out with the same test parameters with concrete formwork parts from the renovation of an old building. The surface to which the new sealing compound was to be applied was first roughly cleaned by removing the old sealing material with a cutting tool. After that, however, the surface still had remains of old sealing compound.

Sealing compound was subsequently applied to a surface region that had only been mechanically treated and to a surface region that had been treated by the handheld plasma-jet unit according to the invention. Apart from the untreated and treated surfaces, the influence of the duration of the treatment with the handheld plasma-jet unit was also investigated. For this purpose, the handheld plasma-jet unit was moved over the surface region at a rate of 19 mm/s, which corresponded to the rate from Example 1, while another surface region was treated at a rate of 9 mm/s, which corresponded to a treatment lasting approximately twice as long.

After four weeks, stress-elongation curves were again measured. The results are represented in FIG. 6. It can be seen that the surface that had only been roughly cleaned mechanically (curve C) exhibits a very poor elongation behaviour, with the result that more laborious cleaning and pretreatment of the surface before the application of the sealing compound is unavoidable. In practice, the old surface is often removed with special tools such as diamond cutters. The surface plasma-treated at a rate of 19 mm/s (curve D) exhibits adhesion properties that are much better by comparison. By allowing the plasma jet to act on the surface for somewhat longer, for example by means of a slower movement of the handheld plasma-jet unit along the surface (here approximately 9 mm/s: curve E), adhesion properties of the sealing compound that are comparable to the fresh, brushed concrete surface from Example 1 can again be achieved.

1-18. (canceled)

19. A device for the treatment of surfaces with a plasma produced under atmospheric pressure having
a plasma nozzle for producing a plasma jet, which comprises a nozzle opening and at least one electrode and counter-electrode pair arranged upstream of the nozzle opening, the effective electrode surfaces of which pair of electrodes each have a dielectric coating, the electrode and the counter-electrode defining between them a working space in which a working gas can be at least partially ionized by means of a dielectric barrier gas discharge,
a high-voltage generator, which is electrically connected to the electrode and counter-electrode pair,
a feeding means, which produces a gas flow of the working gas from a working gas source into the working space and through the nozzle opening, the working gas source being ambient air, and
a mains-independent energy source for supplying the high-voltage generator and the feeding means.

20. A device according to claim 19, wherein the electrode and the counter-electrode are formed as planar electrode plates arranged parallel to each other.

21. A device according to claim 19, wherein the dielectric coating consists of a material selected from the group consisting of a ceramic material, such as aluminium oxide or boron nitride, quartz glass and diamond.

22. A device according to claim 19, wherein the clear distance between the electrode and the counter-electrode lies in the range from 0.1 mm to 10 mm.

23. A device according to claim 19, wherein the width of the electrode and of the counter-electrode transversely in relation to the direction of the gas flow lies in the range from 5 to 100 mm.

24. A device according to claim 19, wherein the high-voltage generator produces anti-symmetric high-voltage pulses, which lie with opposite polarity at the electrode and the counter-electrode at the same time.

25. A device according to claim 24, wherein the pulse duration of the high-voltage pulses is less than 1 μs.

26. A device according to claim 19, wherein the high-voltage generator produces high-voltage pulses with an amplitude in the range from 1 to 20 kV.

27. A device according to claim 19, wherein the power consumption of the high-voltage generator and of the feeding means is at most 20 W.

28. A device according to claim 19, wherein the mains-independent energy source comprises one or more batteries or storage batteries.

29. A device according to claim 19, wherein the plasma jet emerging from the nozzle opening contains at least one marking substance.

30. A device according to claim 29, wherein the marking substance is sucked into the plasma nozzle from a reservoir integrated in the device.

31. A device according to claim 19, wherein the device is formed as an integrated portable handheld unit.

32. A method comprising producing a plasma jet from ambient air with the device of claim 19 and treating a surface of at least one component with the plasma jet.

33. A method according to claim 32, wherein said surface comprises two or more joined parts.

34. A method according to claim 33, wherein an integral bond is produced between the parts being joined by using an adhesive or a sealant after the treatment with the plasma jet.

35. A method according to claim 32, wherein the surface is a surface of a joint formed between two structural elements.

36. A method according to claim 35, wherein the joint is sealed with a sealing material after the surface treatment.
